(19) United States
(12) Patent Application Publication
(10) Pub. No.: US 2008/0022626 A1
(43) Pub. Date: Jan. 31, 2008

(54) Floor Covering Having Two Distinct Representations

(76) Inventor: Johnny Wing Fuk Wong, Hong Kong (CN)

Correspondence Address: Johnny Wing Fuk Wong, BASEMENT A I U-LAM TERRACE, Central, HK

(21) Appl. No.: 11/629,163

(22) PCT Filed: Jul. 19, 2004
(86) PCT No.: PCT/IB04/51256

§ 371 Date: Dec. 11, 2006

(51) Int. Cl. B44F 1/10; E04F 15/02

(52) U.S. Cl. 52/745.05

(57) ABSTRACT

The surface structure of said floor covering is characterized by a minimum of two inclined planes (1,2) forming an angle respective to the vertical (FIG. 1). The resulting elements are arranged successively in such a way that each inclined plane is parallel to the corresponding plane of the consecutive element. This results in the floor covering being able to display a minimum of two distinct representations, which can each be an image, text, pattern, symbol, colour, texture or combinations thereof.

The invention relates to informative and decorative floor coverings, such as carpets, rugs, mats, tiles and floor panels of various materials. Furthermore, said floor coverings contain more than one distinct representation on their surface, with the effect that when viewed from determined viewpoints a different representation is revealed to the observer.

Informative floor coverings widely exist to guide traffic or pedestrian flow and to display messages. The disadvantage of existing floor coverings is that the information contained thereon only works in one direction, i.e. when viewed from the opposing side the information is no longer readable as the letters or signs are seen upside down.

Decorative floor coverings featuring a structured surface resembling that of some preferred embodiments of the present invention exist in the field of tufted rugs and ceramic tiles. However, these surfaces do not intend to display different information when observed from different viewpoints and, as such, contain only one representation on their surface.

The objective of the present invention is to display more than one representation in a floor covering. A representation could be an image, text, pattern, symbol, colour, texture or combinations thereof. Viewed from a determined viewpoint the observer shall see one representation, while viewing the floor covering from other determined viewpoints the observer shall see other distinct representations on said surface.

According to the invention, the objective has been achieved by a floor covering whose surface structure is characterized by a minimum of two inclined planes forming an angle respective to the vertical. The resulting elements are arranged successively in such a way that each inclined plane is parallel to the corresponding plane of the consecutive element. Each plane holds a representation on its surface with the effect that when observed at normal standing height from determined viewpoints the totality of the corresponding parallel planes contained on said surface appear as a continuous surface that reveals one unified representation. This results in the floor covering being able to display a minimum of two distinct representations, which can each be an image, text, pattern, symbol, colour, texture or combinations thereof.

The present invention will be described below in a more detailed manner, with reference to the attached drawings, in which:

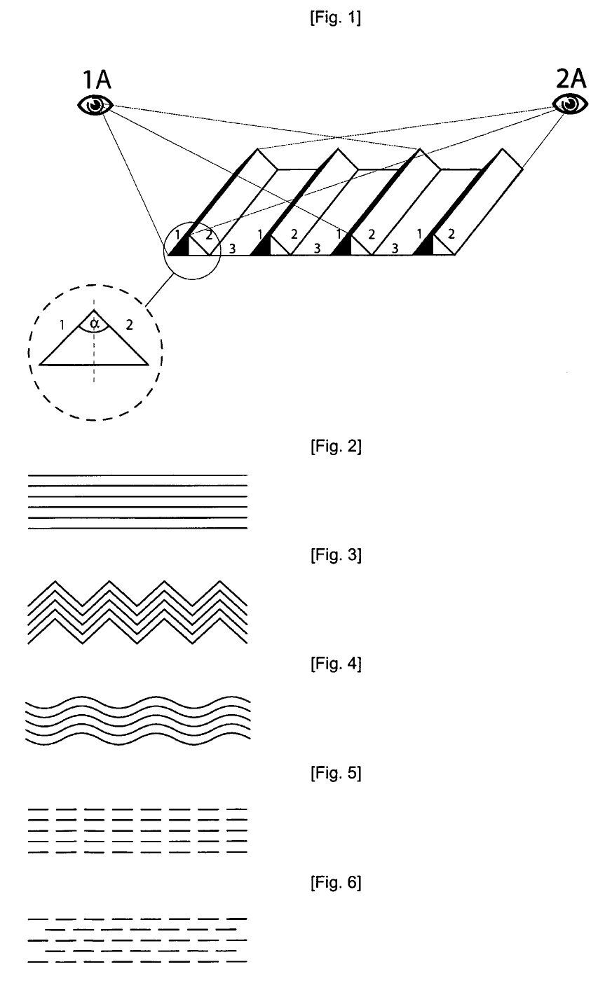

FIG. 1 is a schematic overview of a preferred embodiment of a floor covering;

FIGS. 2-7 are top plan views of preferred arrangements of consecutive triangular prisms or waves;

FIG. 8 is an embodiment of a variation of the present invention, with the surface structure being filled with a clear resin;

The invention relates to floor coverings such as carpets, rugs, mats, tiles and floor panels of various materials. The surface of said floor coverings is of such structure, that when viewed from different angles a different representation is revealed on the surface.

In detail the surface structure is made up of inclined planes forming an angle relative to the vertical (ff ‘protruding elements’). These planes can be straight or curved and connected to a surface base resemble in section a triangle or wave or combinations thereof, for example a rounded off triangle.

In the blown-up section of FIG. 1 the two planes 1 and 2 form an angle a relative to the vertical which is represented by a dotted line. In this example, the planes 1 and 2 resemble the shape of a triangle when viewed in section.

Each of the planes features a representation on its exposed side. This ornamentation of the planes can either be applied superficially, e.g. painted, or be inherent to the material, or be a combination of both. The surface of the planes may additionally be covered with a clear protective layer or film to enhance its wear and tear resistance.

Three dimensional embodiments of the protruding elements are various polyhedrons, i.e. three dimensional geometric figures comprised of polygonal planes. Preferred embodiments where two planes form an angle are triangular prisms (see FIG. 1) or three dimensional waves. Where more than two planes form an angle preferred embodiments are N-sided pyramids, such as triangular pyramids, square pyramids, pentagonal pyramids, hexagonal pyramids etc.

It needs to be noted that the term ‘pyramid’ is an approximation and depending on the curvature of the planes these might be rounded or with their apex rounded off.

Said polyhedrons are arranged successively on said surface in such a way that each inclined plane is parallel to the corresponding plane of the consecutive element. In FIG. 1 all planes 1 and all planes 2 are parallel.

Viewed from determined viewpoints at normal standing height only the planes facing the observer can be seen while the other planes remaining hidden from view because of the solid protruding elements causing a geometric occultation. In order to achieve the desired effect the height and pitch of the inclined planes need to be adjusted according to surface material, surface cover area and desired effect.

Observed from determined viewpoints the floor covering surface is seen as one continuous surface which is made up of the sum of the individual parallel planes facing the observer. The totality of planes seen as one continuous surface reveals a unified representation, which can be an image, text, pattern, symbol, colour, texture or combinations thereof. Viewed from another determined viewpoint another distinct representation is revealed to the observer. The surface can contain as many representations as there are exposed planes.

In FIG. 1 the triangular prisms are arranged to form a zigzag surface structure featuring spaces in between the protruding elements. Spaces in between protruding elements are optional. However, these horizontal spaces can also contain a representation, which will be best seen from a viewpoint vertical to the surface, e.g. when walking over the floor covering. In FIG. 1 the observers at viewpoint 1A and 2A each see a distinct representation on the surface of the floor covering. An observer at viewpoint 1A would see the totality of planes 1 while an observer at viewpoint 2A would see the totality of planes 2. Moving closer to the surface the occultation lessens and the observers will see combinations of the representations contained on said surface, in this example a combination of the representations held on planes 1, 2, and 3.

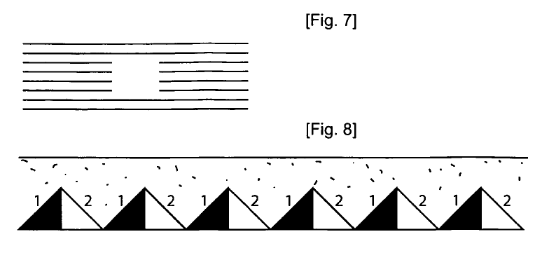

The polyhedrons can be arranged in various patterns, as long as the corresponding inclined planes are parallel, FIGS. 2 to 7 depict preferable arrangements for triangular prisms and waves in top plan view. Preferable arrangements of the consecutive triangular prisms and waves are straight rows (FIG. 2), zigzag pattern (FIG. 3) or curves (FIG. 4) or combinations thereof. The triangular prisms or waves can also be interrupted in a regular or irregular fashion as is depicted in top plan view by two preferred embodiments in FIGS. 5 and 6 respectively. Also, a blank or level space may be left out for other uses, such as to place furniture or to leave flat space for a single representation that does not change appearance with a change of viewpoint. A preferred embodiment can be seen in FIG. 7.

N-sided pyramids can be arranged freely, as long as the corresponding inclined planes remain parallel.

FIG. 8 shows an embodiment of a variation of the present invention, where the surface structure is filled in with a clear resin. This resin is a measure to protect the crests or apexes of the angled planes from wear and tear and facilitates cleaning. It also allows for a smooth surface where such is needed, e.g. where wheeled objects need to be moved. As the resin is transparent the optical effect of the surface holding more than one distinct representation remains the same as explained above.

The same results as in above variation are achieved by mounting a flat and rigid transparent sheet, e.g. glass, on top of the crests or apexes of said floor covering.

Another variation of the present invention is the vertical application of said floor coverings. In this variation the floor coverings as explained above would but used on interior or exterior walls. Examples are wall rugs or floor tiles that can also be used for cladding walls.

Applied in public areas the floor coverings can give detailed information to incoming or outgoing visitors and point them into the right direction. Incoming information remains ‘hidden’ from outgoing visitors and vice versa.

Applied to tiles the invention provides a new tool for architects to create building surfaces that change appearance depending on the viewpoint.

1. Method for producing a multi-sided floor covering, with the property of revealing on its surface at least two distinct and different representations, in particular guidance-giving and/or decorative signs, text, graphics, colours or colour patterns, with each representation being visible exclusively and entirely from determined view points and the method of producing such floor covering characterized in that equally shaped n-sided protrusions are arranged in rows on said surface with all planes of the same orientation parallel to each other; each of these planes contains on its surface a fraction of a representation and when seen as a whole the combined planes of one orientation reveal one distinct representation to an observer while the combined planes of another orientation reveal each another distinct representation.

2. A method to produce a multi-sided floor covering according to claim 1 with the aforementioned protrusions mounted to a flat base or backing.

3. A method to produce a multi-sided floor covering according to claims 1-2 wherein said protrusions are in the shape of regular triangular prisms.

4. A method to produce a multi-sided floor covering according to claims 1-2 wherein said protrusions are in the shape of waves.

5. A method to produce a multi-sided floor covering according to claims 1-2 wherein said protrusions are in the shape of either 3-, 4-, or 5-sided pyramids.

6. A method to produce a multi-sided floor covering according to claims 1-5 with the representations embedded within the material structure by such methods as embossing, engraving, tufting, casting, extruding or moulding.

7. A method to produce a multi-sided floor covering according to claims 1-5 with the representations superficially applied to the surface by either spraying, screening, painting or by applying adhesive tapes or stickers.

8. A method to produce a multi-sided floor covering according to claims 3 and where the apex of said triangular prisms or n-sided pyramids is rounded off.

9. A method to produce a multi-sided floor covering according to claim 3 characterized in that there is a gap running vertically through the vertex of the triangular prisms.

10. A method to produce a multi-sided floor covering according to claims 1-9 which further comprises the step of adding a clear, see-through resin on top of the surface up to a height higher than the apexes of the protrusions with the resulting surface of the resin being level and smooth.
